(19) United States
(12) Patent Application Publication
(10) Pub. No.: US 2026/0261828 A1
(43) Pub. Date: Sep. 3, 2026

(54) Wireless communication apparatus having moving object detection mechanism and moving object detection method thereof

(71) Applicant: REALTEK SEMICONDUCTOR CORPORATION, HSINCHU (TW)

(72) Inventors: WEI-CHI LAI, HSINCHU (TW); SHAO-ZHEN HE, HSINCHU (TW); WEI-HSUAN CHANG, HSINCHU (TW)

(21) Appl. No.: 19/468,146

(22) Filed: Feb. 3, 2026

(30) Foreign Application Priority Data
Feb. 25, 2025 (TW) 114106992

(51) Int. Cl. H04W 4/38; H04L 25/02; H04L 27/26

(52) U.S. Cl. CPC H04W 4/38; H04L 25/0212; H04L 25/022; H04L 27/2634

(57) ABSTRACT

A moving object detection method used in a wireless communication apparatus is provided that includes steps outlined below. A wireless signal transmitted in a predetermined space is received. The wireless signal is processed to generate channel impulse response information on a time domain. A statistical analysis along with time is performed according to the impulse response information to generate at least one statistical parameter. A moving object is determined to be present in the predetermined space according to the statistical parameter within a predetermined value range.

### BACKGROUND OF THE INVENTION

### 1. Field of the Invention

The present invention relates to a Wireless communication apparatus having a moving object detection mechanism and a moving object detection method thereof.

### 2. Description of Related Art

The moving object detection technology can be used in in a family environment to monitor whether an elder falls down or whether an accident occurs. A common moving object detection technology uses sensors or cameras disposed in a space to perform detection. However, the disposition of sensors requires an additional cost. The disposition of cameras not only requires an additional cost, but also causes a negative emotion on the object being monitored due to the invasion of privacy. A technology that is able to perform the moving object detection in an indoor environment with a low disposition cost and without the invasion of privacy is required.

### SUMMARY OF THE INVENTION

In consideration of the problem of the prior art, an object of the present invention is to supply a Wireless communication apparatus having a moving object detection mechanism and a moving object detection method thereof.

The present invention discloses a moving object detection method used in a wireless communication apparatus that includes steps outlined below. A wireless signal transmitted in a predetermined space is received. The wireless signal is processed to generate channel impulse response (CIR) information on a time domain. A statistical analysis along with a variation of time is performed according to the channel impulse response information to generate at least one statistical parameter. A moving object is determined to be present in the predetermined space according to the statistical parameter within a predetermined value range.

The present invention also discloses a wireless communication apparatus having a moving object detection mechanism that includes an antenna, a communication circuit and a processing circuit. The communication circuit is electrically coupled to the antenna. The processing circuit is electrically coupled to the communication circuit and is configured to receive a wireless signal transmitted in a predetermined space through the communication circuit and the antenna, process the wireless signal to generate channel impulse response information on a time domain, perform a statistical analysis along with a variation of time according to the channel impulse response information to generate at least one statistical parameter and determine a moving object is presented in the predetermined space according to the statistical parameter within a predetermined value range.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a wireless communication apparatus having a moving object detection mechanism according to an embodiment of the present invention.

FIG. 2 illustrates a diagram of the channel impulse response information according to an embodiment of the present invention.

FIG. 3 illustrates a diagram of the relation of the packets included in the wireless signal received by the wireless communication apparatus and the difference of the intensity sum related to the channel frequency response of the wireless signal in some approaches.

FIG. 4A and FIG. 4B illustrate diagrams of the relation of the packets included in the wireless signal received by the wireless communication apparatus and the weighted delay parameter and the variance related to the channel impulse response of the wireless signal according to an embodiment of the present invention.

FIG. 5 illustrates a flow chart of a moving object detection method according to an embodiment of the present invention.

FIG. 6 illustrates a flow chart of a moving object detection method according to an embodiment of the present invention.

### DETAILED DESCRIPTION OF THE PREFERRED EMBODIMENTS

An aspect of the present invention is to provide a Wireless communication apparatus having a moving object detection mechanism and a moving object detection method thereof to perform a statistical analysis along with a variation of time according to channel impulse response information on a time domain to generate a statistical parameter, such that a high precision detection and determination can be performed on a moving object in a predetermined space according to the statistical parameter having a notable variation.

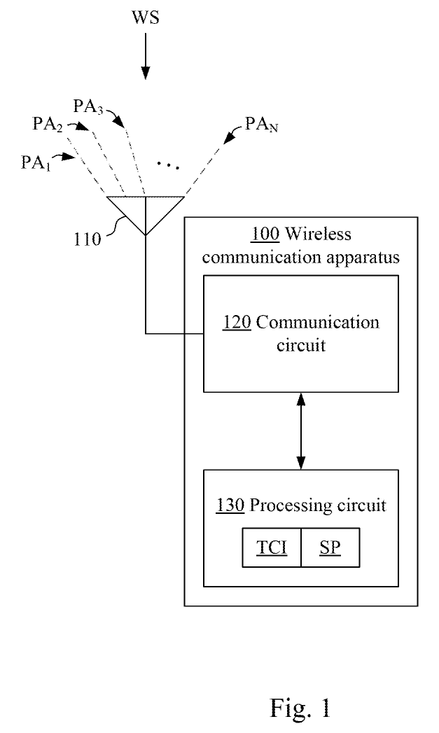

Reference is now made to FIG. 1. FIG. 1 illustrates a block diagram of a wireless communication apparatus 100 having a moving object detection mechanism according to an embodiment of the present invention. The wireless communication apparatus 100 includes an antenna 110, a communication circuit 120 and a processing circuit 130.

In FIG. 1, the number of the antenna 110 is illustrated to be 1. In practical implementation, the antenna 110 having the number of more than 1 can be disposed in the wireless communication apparatus 100. It is appreciated that the antenna 110 is illustrated to be outside the wireless communication apparatus 100 in FIG. 1. However, the antenna 110 is actually a part of the wireless communication apparatus 100. The communication circuit 120 is electrically coupled to the antenna 110 and is a circuit configured to perform wireless communication according to wireless communication technology. The processing circuit 130 is electrically coupled to the communication circuit 120 to perform wireless communication with an external device through the communication circuit 120 and the antenna 110.

In an embodiment, the wireless communication apparatus 100 can be disposed in a predetermined space (not illustrated in the figure) and perform wireless communication with the external device also disposed in such a predetermined space. In a usage scenario, the wireless communication apparatus 100 can be an electronic apparatus disposed in a living room and can perform wireless communication with an access point (AP) device also disposed in the living room.

The wireless communication apparatus 100 has a moving object detection mechanism to perform detection on a moving object (e.g., a moving human body or a moving stuff) according to the wireless communication performed with the external device. The operation of the moving object detection mechanism performed by the wireless communication apparatus 100 is described in the following paragraphs.

At first, the processing circuit 130 receives a wireless signal WS transmitted in a through the communication circuit 120 and the antenna 110.

In different embodiments, the processing circuit 130 may receive the wireless signal WS from an external apparatus through the communication circuit 120 and the antenna 110 that is transmitted by using such as, but not limited to one of WiFi wireless communication technology, Bluetooth wireless communication technology and Global System for Mobile Communications (GSM) wireless communication technology. It is appreciated that in other embodiments, the wireless signal WS may also be transmitted by using other wireless communication technologies. The present invention is not limited thereto.

In an embodiment, the antenna 110 does not only receive the wireless signal WS from a single path in the predetermined space. More specifically, when the wireless signal WS is transmitted in predetermined space, a multi-path effect occurs due to refraction and reflection such that the wireless signal WS is transmitted to the antenna 110 through a plurality of signal transmission paths PA₁~PA_{N} illustrated as dashed lines in FIG. 1. The processing circuit 130 further receives the wireless signal WS through the communication circuit 120 and the antenna 110 from these signal transmission paths PA₁~PA_{N} in the predetermined space.

Subsequently, the processing circuit 130 processes the wireless signal WS to generate channel impulse response (CIR) information TCI on a time domain.

In an embodiment, when the processing circuit 130 receives the wireless signal WS through the communication circuit 120 by using such as, but not limited to Orthogonal frequency-division multiplexing (OFDM) technology in the WiFi wireless communication technology, the processing circuit 130 first processes the wireless signal WS to generate channel frequency response (CFR) information (not illustrated in the figure) on a frequency domain and further performs inverse fast Fourier transform (IFFT) on the channel frequency response information to generate the channel impulse response information TCI.

In an embodiment, when the processing circuit 130 receives the wireless signal WS through the communication circuit 120 by using such as, but not limited to Global System for Mobile Communications wireless communication technology, the processing circuit 130 performs estimation according to a training sequence (not illustrated in the figure) included by the wireless signal WS by using such as, but not limited to the technology described in the article “Estimation of the Channel Impulse Response for GSM System” in the book “Personal Wireless Communications”, to generate the channel impulse response information TCI.

In other embodiments, the processing circuit 130 may use different methods to generate the channel impulse response information TCI according to the different wireless communication technologies being used.

In an embodiment, the channel impulse response information TCI reflects the multi-path effect of the signal transmission paths PA₁~PA_{N} when the wireless communication apparatus 100 receives the wireless signal WS from an external device. More specifically, the channel impulse response information TCI includes a plurality of groups of path response parameters of the plurality of signal transmission paths, each group of the plurality of groups of path response parameters including a signal amplitude and a path delay.

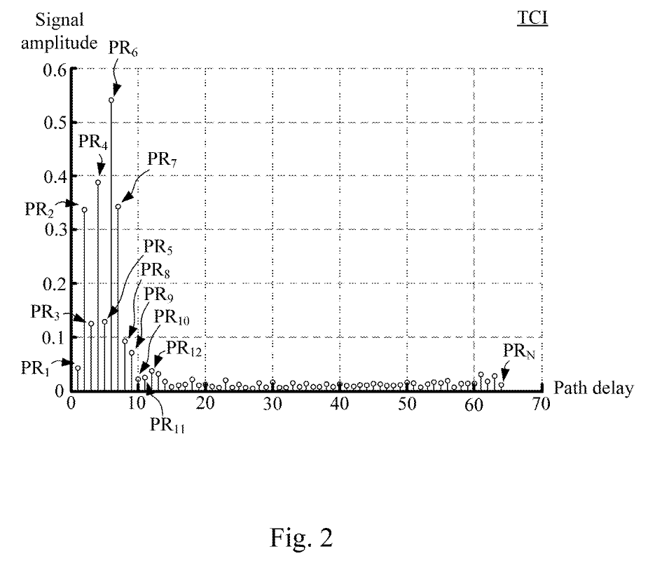

Reference is now made to FIG. 2 at the same time. FIG. 2 illustrates a diagram of the channel impulse response information TCI according to an embodiment of the present invention. In FIG. 2, the X-axis represents the amount of the path delay and the Y-axis represents the amount of the signal amplitude. A plurality of vertical lines illustrated in FIG. 2 represents a plurality of groups of path response parameters PR₁~PR_{N}. In FIG. 2, only PR₁~PR₁₂ and PR_{N} are exemplarily labeled.

As described above, each group of path response parameters PR₁~PR_{N} include a signal amplitude and a path delay. Take the path response parameters PR₁ as an example, the signal amplitude thereof is 0.04, and the path delay thereof is 1. Following the same rationale, the path response parameters PR₂~PR₁₂in turn include the signal amplitudes of 0.33, 0.12, 0.39, 0.12, 0.55, 0.34, 0.1, 0.08, 0.01, 0.02 and 0.03 and the path delays of 2, 3, 4, 5, 6, 7, 8, 9, 10, 11 and 12.

The processing circuit 130 further performs statistical analysis along with a variation of time according to the channel impulse response information TCI to generate at least one the statistical parameter SP.

In an embodiment, the processing circuit 130 multiplies the signal amplitude and the path delay of each group of the plurality of groups of path response parameters (e.g., the path response parameters PR₁~PR_{N}) to generate multiplication results. For example, for the path response parameters PR₁, the multiplication result is generated by multiplying the signal amplitude of 0.04 and the path delay of 1 and is 0.04. Following the same rationale, for the path response parameters PR₂~PR₁₂, the multiplication results in turn are 0.66 (0.33×2), 0.36 (0.12×3), 1.56 (0.39×4), 0.6 (0.12×5), 3.3 (0.55×6), 2.38 (0.34×7), 0.8 (0.1×8), 0.72 (0.08×9), 0.1 (0.01×10), 0.22 (0.02×11) and 0.36 (0.03×12).

The path response parameters from the path response parameters PR₁₂ to the path response parameters PR_{N} in turn include the corresponding signal amplitude and path delay, and the multiplication results thereof can be generated by using the same method. The detail is not described herein.

The processing circuit 130 performs an adding process on the multiplication results of the path response parameters to generate weighted delay parameter.

In an embodiment, the processing circuit 130 ranks the path response parameters PR₁~PR_{N} according to the signal amplitude from a largest signal amplitude to a lowest signal amplitude signal amplitude and only adds the multiplication results of the plurality of groups of path response parameters corresponding to M largest amplitudes being ranked to perform the adding process to generate the weighted delay parameter.

Take the value of M being 10 as an example, in the example in FIG. 2, the path response parameters corresponding to 10 largest amplitudes being ranked are in turn the path response parameters PR₆ (the signal amplitude is 0.55), PR₄ (the signal amplitude is 0.39), PR₇ (the signal amplitude is 0.34), PR (the signal amplitude is 0.33), PR₃, PR₅ (the signal amplitudes are both 0.12), PR₈ (the signal amplitude is 0.1), PR₉ (the signal amplitude is 0.08), PR₁ (the signal amplitude is 0.04) and PR₁₂ (the signal amplitude is 0.03). The signal amplitudes of the other path response parameters are smaller than the signal amplitudes described above. As a result, the processing circuit 130 adds the multiplication results of the path response parameters corresponding to the 10 largest signal amplitudes to generate the weighted delay parameter that is 3.3+1.56+2.38+0.66+0.36+0.6+0.8+0.72+0.04+0.36=10.78.

In other embodiments, the processing circuit 130 may select the required multiplication results from the path response parameters PR₁~PR_{N} by using other methods to perform the adding process to generate the weighted delay parameter, or perform the adding process on the multiplication results of all the path response parameters PR₁~PR_{N} to generate the weighted delay parameter when the operation resource is sufficient. The present invention is not limited thereto.

The processing circuit 130 further performs statistical analysis along with a variation of time on the weighted delay parameter to generate the statistical parameter SP. More specifically, the processing circuit 130 may generate the weighted delay parameter corresponding to different time spots by using the method described above and performs statistical analysis on the weighted delay parameters corresponding to different time spots.

In an embodiment, the processing circuit 130 sets a sliding window to calculate a variance of the weighted delay parameter corresponding to a plurality of time spots in the sliding window as the statistical parameter SP. In an embodiment, the processing circuit 130 may also set a sliding window to calculate an average value of the weighted delay parameter corresponding to a plurality of time spots in the sliding window as the statistical parameter.

The processing circuit 130 further determines a moving object is presented in the predetermined space according to the statistical parameter SP within a predetermined value range.

Take the statistical parameter SP in the form of the variance as an example, the processing circuit 130 may determine that the statistical parameter SP is within predetermined value range under the condition that the variance of the weighted delay parameters in the sliding window is larger than a predetermined threshold so as to determine that a moving object is presented in the predetermined space.

It is appreciated that since the number of the antennas included in the wireless communication apparatus 100 may be larger than 1 and the different antennas are located differently in the predetermined space, the processing circuit 130 may generate different channel impulse response information TCI according to the different antennas and further generate different statistical parameters SP. The processing circuit 130 may set different predetermined value ranges corresponding to the different statistical parameters SP to perform determination and further determine whether the moving object is presented in the predetermined space according to one or more than one determination results.

For example, when the number of the antennas is 2, the processing circuit 130 may set a first predetermined value range corresponding to the first antenna to perform determination on the first statistical parameter and set a second predetermined value range corresponding to the second antenna to perform determination on the second statistical parameter. The processing circuit 130 may determine that the moving object is presented in the predetermined space when one of the statistical parameters is within the corresponding predetermined value range or when both of the statistical parameters are within the respective predetermined value ranges. However, it is appreciated that the number of the antennas and the number of the statistical parameters that the processing circuit 130 uses to perform determination described above are merely an example. The present invention is not limited thereto.

Moreover, the processing circuit 130 may set a plurality of parameter value ranges corresponding to the statistical parameter SP to determine a moving speed and/or a moving direction of the moving object according to one of the parameter value ranges that the statistical parameter SP locates in different times.

In some approaches, after generating the channel frequency response information in the frequency domain according to the received wireless signal, the wireless communication apparatus directly detects the moving object according to the channel frequency response information. However, whether the moving object is presented or not does not significantly affect the channel frequency response information. The channel frequency response information thus cannot be used to perform an accurate detection on the moving object.

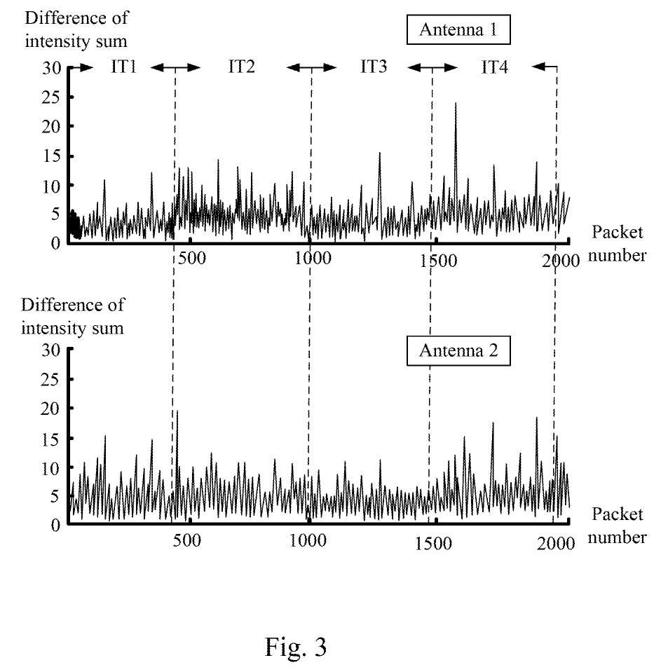

Reference is now made to FIG. 3. FIG. 3 illustrates a diagram of the relation of the packets included in the wireless signal received by the wireless communication apparatus and the difference of the intensity sum related to the channel frequency response of the wireless signal in some approaches.

In such an example, the wireless communication apparatus has two antennas. The upper half of FIG. 3 and the lower half of FIG. 3 respectively are labeled as “antenna 1” and “antenna 2” to represent the data related thereto. Corresponding to the upper half of FIG. 3, the X-axis represents the sequence numbers of the packets (labeled as packet number in FIG. 3) and the Y-axis represents the difference of the intensity sum. Similarly, corresponding to the lower half of FIG. 3, the X-axis represents the sequence numbers of the packets and the Y-axis represents the difference of the intensity sum. For the difference of the intensity sum that the Y-axis represents, each of the values thereof is a difference between the intensity sum of the channel frequency response that a current packet corresponds to and the intensity sum of the channel frequency response that a previous packet corresponds to.

The X-axis in FIG. 3 is divided into intervals IT1~IT4, wherein no moving object is presented in the intervals IT1 and IT3 (i.e., no object is moving in the predetermined space that the wireless communication apparatus locates) and a moving object is presented in the intervals IT2 and IT4 (i.e., an object is moving in the predetermined space that the wireless communication apparatus locates).

The values of the difference of the intensity sum that the Y-axis corresponds to do not vary much in the intervals T1~T4. Such a condition means that a significant variation of the difference of the intensity sum is absent. Such a characteristic does not allow the channel frequency response information on the frequency domain to be used to perform an accurate moving object detection.

On the contrary, the wireless communication apparatus of the present invention uses the channel impulse response information on the time domain to perform statistical analysis along with the variation of time to generate the statistical parameter SP, such that a detection and a determination of the moving object in the predetermined space with high accuracy can be performed according to the statistical parameter SP having a significant variation.

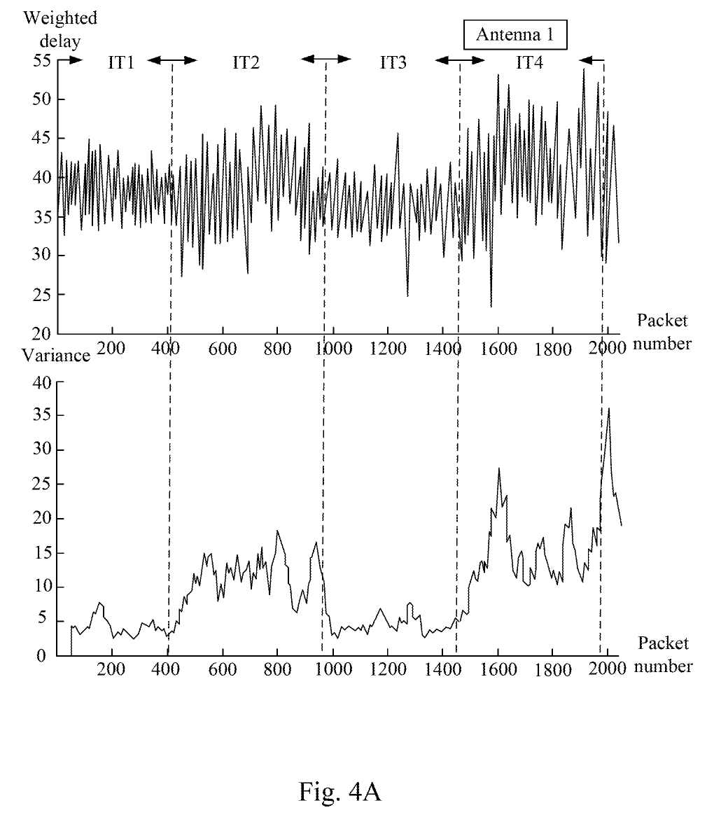

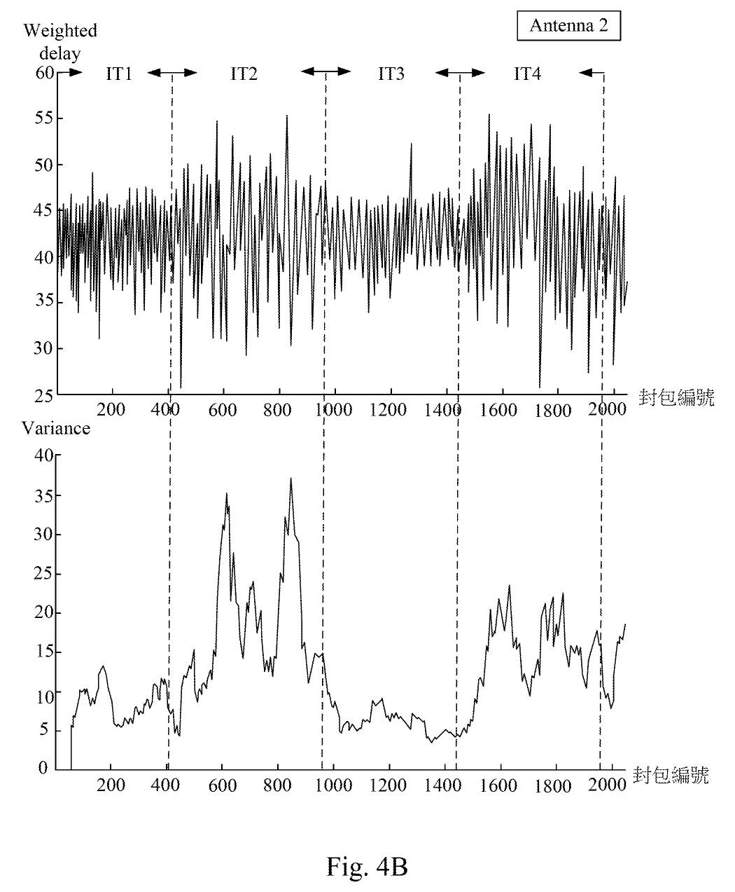

Reference is now made to FIG. 4A and FIG. 4B at the same time. FIG. 4A and FIG. 4B illustrate diagrams of the relation of the packets included in the wireless signal WS received by the wireless communication apparatus 100 and the weighted delay parameter and the variance related to the channel impulse response of the wireless signal WS according to an embodiment of the present invention.

In such an example, the wireless communication apparatus has two antennas. FIG. 4A and FIG. 4B respectively are labeled as “antenna 1” and “antenna 2” to represent the data related thereto. Corresponding to the upper half of FIG. 4A and FIG. 4B, the X-axis represents the sequence numbers of the packets (labeled as packet number in FIG. 4) and the Y-axis represents the weighted delay parameter generated according to the channel impulse response information TCI. Corresponding to the lower half of FIG. 4A and FIG. 4B, the X-axis represents the sequence numbers of the packets and the Y-axis represents the variance generated according to the weighted delay parameter.

The X-axis in each of FIG. 4A and FIG. 4B is divided into intervals IT1~IT4, wherein no moving object is presented in the intervals IT1 and IT3 (i.e., no object is moving in the predetermined space that the wireless communication apparatus locates) and a moving object is presented in the intervals IT2 and IT4 (i.e., an object is moving in the predetermined space that the wireless communication apparatus locates).

As illustrated in FIGS. 4A and 4B, the values of the variance have a significant variation in the intervals IT1~IT4 along with the presence and the absence of the moving object. More specifically, the variance in the intervals T2 and T4 that the moving object is presented is twice the variance in the intervals T1 and T3 that the moving object is not presented.

As a result, the variance of the weighted delay parameter has a significant variation along with the presence and the absence of the moving object. Such a characteristic allows the channel impulse response information on the time domain to be used to perform an accurate moving object detection.

It is appreciated that in different embodiments, the processing circuit 130 may set different lengths of the sliding window according to practical requirements and perform statistical analysis along with the slide of time. When the length of the sliding window is set to be shorter, the detection of the moving object is performed with a lower operation amount. However, the accuracy is lower. When the length of the sliding window is set to be longer, the detection of the moving object is performed with a larger operation amount. However, the accuracy is higher. For example, if the length of the sliding window exceeds 5 units, more data is used to perform statistical analysis such that the accuracy of the moving object detection is increased due to the increasing of the operation amount. If the length of the sliding window is less than 5 units, less data is used to perform statistical analysis such that the accuracy of the moving object detection is decreased due to the decreasing of the operation amount.

In different embodiments, the processing circuit 130 may use other statistical analysis method apart from the variance and average. The present invention is not limited to a specific statistical analysis method.

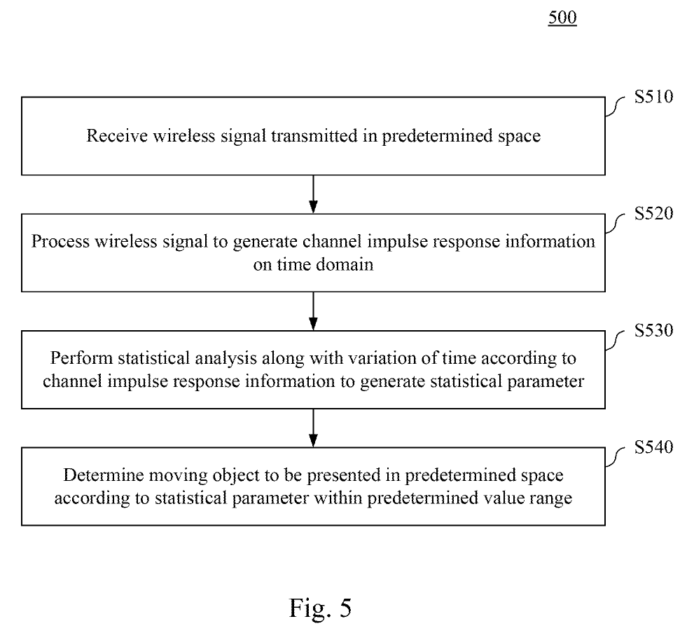

Reference is now made to FIG. 5. FIG. 5 illustrates a flow chart of a moving object detection method 500 according to an embodiment of the present invention.

In addition to the apparatus described above, the present disclosure further provides the moving object detection method 500 that can be used in such as, but not limited to, the wireless communication apparatus 100 in FIG. 1. As illustrated in FIG. 5, an embodiment of the moving object detection method 500 includes the following steps.

In step S510, the wireless signal WS transmitted in the predetermined space is received.

In step S520, the wireless signal WS is processed to generate the channel impulse response information TCI on the time domain.

In step S530, the statistical analysis along with the variation of time is performed according to the channel impulse response information TCI to generate at least one statistical parameter SP.

In step S540, the moving object is determined to be presented in the predetermined space according to the statistical parameter SP within the predetermined value range.

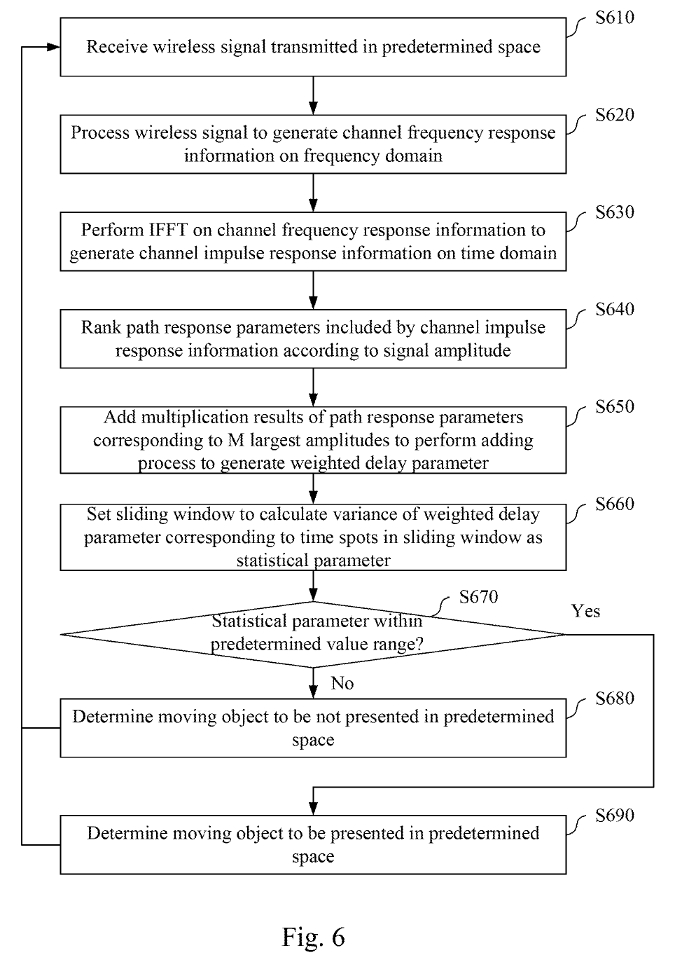

Reference is now made to FIG. 6. FIG. 6 illustrates a flow chart of a moving object detection method 600 according to an embodiment of the present invention. Compared to the moving object detection method 500 illustrated in FIG. 5, the moving object detection method 600 in FIG. 6 illustrates a more detailed flow under a usage scenario and includes steps outlined below.

In step S610, the wireless signal WS transmitted in the predetermined space is received.

In step S620, the wireless signal WS is processed to generate the channel frequency response information on the frequency domain.

In step S630, the inverse fast Fourier transform is performed on the channel frequency response information to generate the channel impulse response information TCI on the time domain.

In step S640, the path response parameters PR₁~PR_{N} included by the channel impulse response information TCI are ranked according to the signal amplitude from a largest signal amplitude to a lowest signal amplitude.

In step S650, the multiplication results of the plurality of groups of path response parameters corresponding to M largest amplitudes being ranked are added to perform the adding process to generate the weighted delay parameter.

In step S660, the sliding window is set to calculate the variance of the weighted delay parameter corresponding to the time spots in the sliding window as the statistical parameter.

In step S670, whether the statistical parameter SP is within the predetermined value range is determined.

In step S680, the moving object is determined to be not presented in the predetermined space when the statistical parameter SP is not within the predetermined value range.

In step S690, the moving object is determined to be presented in the predetermined space when the statistical parameter SP is within the predetermined value range.

After step S680 and step S690, the flow goes back to step S610 to keep receiving the wireless signal WS and performing subsequent steps.

It is appreciated that the embodiments described above are merely an example. In other embodiments, it should be appreciated that many modifications and changes may be made by those of ordinary skill in the art without departing, from the spirit of the disclosure.

In summary, the present invention discloses the Wireless communication apparatus having the moving object detection mechanism and the moving object detection method thereof to perform a statistical analysis along with a variation of time according to channel impulse response information on a time domain to generate a statistical parameter, such that a high precision detection and determination can be performed on a moving object in a predetermined space according to the statistical parameter having a notable variation.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A moving object detection method used in a wireless communication apparatus, comprising:
receiving a wireless signal transmitted in a predetermined space;
processing the wireless signal to generate channel impulse response (CIR) information on a time domain;
performing a statistical analysis along with a variation of time according to the channel impulse response information to generate at least one statistical parameter; and
determining a moving object is presented in the predetermined space according to the statistical parameter within a predetermined value range.

2. The moving object detection method of claim 1, further comprising:
receiving the wireless signal from a plurality of signal transmission paths in the predetermined space, wherein the channel impulse response information comprises a plurality of groups of path response parameters of the plurality of signal transmission paths, each group of the plurality of groups of path response parameters comprising a signal amplitude and a path delay;
multiplying the signal amplitude and the path delay of each group of the plurality of groups of path response parameters to generate multiplication results;
performing an adding process on the multiplication results of the plurality of groups of path response parameters to generate a weighted delay parameter; and
performing the statistical analysis along with the variation of time on the weighted delay parameter to generate the statistical parameter.

3. The moving object detection method of claim 2, further comprising:
ranking the plurality of groups of path response parameters according to the signal amplitude from a largest signal amplitude to a lowest signal amplitude; and
only adding the multiplication results of the plurality of groups of path response parameters corresponding to M largest amplitudes being ranked to perform the adding process to generate the weighted delay parameter.

4. The moving object detection method of claim 2, wherein the statistical analysis comprises:
setting a sliding window to calculate a variance of the weighted delay parameter corresponding to a plurality of time spots in the sliding window as the statistical parameter.

5. The moving object detection method of claim 2, wherein the statistical analysis comprises:
setting a sliding window to calculate an average value of the weighted delay parameter corresponding to a plurality of time spots in the sliding window as the statistical parameter.

6. The moving object detection method of claim 1, further comprising:
processing the wireless signal to generate channel frequency response (CFR) information on a frequency domain to further perform an inverse fast Fourier transform (IFFT) on the channel frequency response information to generate the channel impulse response information.

7. The moving object detection method of claim 1, further comprising:
performing estimation according to a training sequence comprised by the wireless signal to generate the channel impulse response information.

8. The moving object detection method of claim 1, further comprising:
setting a plurality of parameter value ranges corresponding to the statistical parameter to determine a moving speed and/or a moving direction of the moving object according to one of the parameter value ranges that the statistical parameter locates in different times.

9. The moving object detection method of claim 1, further comprising:
receiving the wireless signal transmitted according to a WiFi wireless communication technology, a Bluetooth wireless communication technology or a Global System for Mobile Communications (GSM) wireless communication technology.

10. A wireless communication apparatus having a moving object detection mechanism, comprising:
an antenna;
a communication circuit electrically coupled to the antenna; and
a processing circuit electrically coupled to the communication circuit and configured to:
receive a wireless signal transmitted in a predetermined space through the communication circuit and the antenna;
process the wireless signal to generate channel impulse response information on a time domain;
perform a statistical analysis along with a variation of time according to the channel impulse response information to generate at least one statistical parameter; and
determine a moving object is presented in the predetermined space according to the statistical parameter within a predetermined value range.

11. The wireless communication apparatus of claim 10, wherein the processing circuit is further configured to:
receive the wireless signal from a plurality of signal transmission paths in the predetermined space through the communication circuit and the antenna, wherein the channel impulse response information comprises a plurality of groups of path response parameters of the plurality of signal transmission paths, each group of the plurality of groups of path response parameters comprising a signal amplitude and a path delay;
multiply the signal amplitude and the path delay of each group of the plurality of groups of path response parameters to generate multiplication results;
perform an adding process on the multiplication results of the plurality of groups of path response parameters to generate a weighted delay parameter; and
perform the statistical analysis along with the variation of time on the weighted delay parameter to generate the statistical parameter.

12. The wireless communication apparatus of claim 11, wherein the processing circuit is further configured to:
rank the plurality of groups of path response parameters according to the signal amplitude from a largest signal amplitude to a lowest signal amplitude; and
only add the multiplication results of the plurality of groups of path response parameters corresponding to M largest amplitudes being ranked to perform the adding process to generate the weighted delay parameter.

13. The wireless communication apparatus of claim 11, wherein the statistical analysis comprises:
setting a sliding window to calculate a variance of the weighted delay parameter corresponding to a plurality of time spots in the sliding window as the statistical parameter.

14. The wireless communication apparatus of claim 11, wherein the statistical analysis comprises:
setting a sliding window to calculate an average value of the weighted delay parameter corresponding to a plurality of time spots in the sliding window as the statistical parameter.

15. The wireless communication apparatus of claim 10, wherein the processing circuit is further configured to:
process the wireless signal to generate channel frequency response information on a frequency domain to further perform an inverse fast Fourier transform on the channel frequency response information to generate the channel impulse response information.

16. The wireless communication apparatus of claim 10, wherein the processing circuit is further configured to:
perform estimation according to a training sequence comprised by the wireless signal to generate the channel impulse response information.

17. The wireless communication apparatus of claim 10, wherein the processing circuit is further configured to:
set a plurality of parameter value ranges corresponding to the statistical parameter to determine a moving speed and/or a moving direction of the moving object according to one of the parameter value ranges that the statistical parameter locates in different times.

18. The wireless communication apparatus of claim 10, wherein the processing circuit is further configured to:
receive the wireless signal transmitted according to a WiFi wireless communication technology, a Bluetooth wireless communication technology or a Global System for Mobile Communications wireless communication technology.
